(19) United States
(12) Patent Application Publication
(10) Pub. No.: US 2013/0229990 A1
(43) Pub. Date: Sep. 5, 2013

(54) METHOD AND APPARATUS FOR MANAGING UPLINK INTERFERENCE

(71) Applicants: Michael Fan, San Diego, CA (US); Jiming Guo, Beijing (CN); Bo Chen, Beijing (CN)

(72) Inventors: Michael Fan, San Diego, CA (US); Jiming Guo, Beijing (CN); Bo Chen, Beijing (CN)

(73) Assignee: Qualcomm Incorporated, San Diego, CA (US)

(21) Appl. No.: 13/578,585

(22) PCT Filed: Oct. 13, 2010
(86) PCT No.: PCT/CN10/77703

§ 371 Date: Sep. 18, 2012

(30) Foreign Application Priority Data
Mar. 12, 2010 (CN) 2010/071000

(51) Int. Cl. H04W 72/04

(52) U.S. Cl. CPC H04W 72/0486
USPC 370/329; 370/328

(57) ABSTRACT

A method and apparatus for effectively managing uplink interference in a TD-SCDMA HSUPA system is provided. The method may comprise receiving a load indicator from each of one or more non-serving Node Bs, calculating a load factor for each of the one or more non-serving Node Bs, generating a weighted serving and neighbor Node B path loss (SNPL) metric by applying the calculated load factor to a non-weighted SNPL metric determination, and transmitting the generated weighted SNPL metric to a serving Node B.

### CROSS-REFERENCE TO RELATED APPLICATION(S)

This application claims the benefit of International Patent Application No. PCT/CN2010/071000, entitled “METHOD AND APPARATUS FOR MANAGING UPLINK INTERFERENCE,” filed on Mar. 12, 2010, which is expressly incorporated by reference herein in its entirety.

### BACKGROUND

1. Field

Aspects of the present disclosure relate generally to wireless communication systems, and more particularly, for effectively managing uplink interference in a system, such as a time division synchronous code division multiple access (TD-SCDMA) high speed uplink packet access (HSUPA) system.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and TD-SCDMA. For example, China is pursuing TD-SCDMA as the underlying air interface in the UTRAN architecture with its existing GSM infrastructure as the core network. The UMTS also supports enhanced 3G data communications protocols, such as High Speed Downlink Packet Access (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection effectively managing uplink interference in a TD-SCDMA HSUPA system. The method can comprise receiving a load indicator from each of one or more non-serving Node Bs, calculating a load factor for each of the one or more non-serving Node Bs, generating a weighted serving and neighbor Node B path loss (SNPL) metric by applying the calculated load factor to a non-weighted SNPL metric determination, and transmitting the generated weighted SNPL metric to a serving Node B.

Yet another aspect relates to an apparatus. The apparatus can include means for receiving a load indicator from each of one or more non-serving Node Bs, means for calculating a load factor for each of the one or more non-serving Node Bs, means for generating a weighted SNPL metric by applying the calculated load factor to a non-weighted SNPL metric determination, and means for transmitting the generated weighted SNPL metric to a serving Node B.

Still another aspect relates to a computer program product comprising a computer-readable medium. The computer-readable medium can include code for receiving a load indicator from each of one or more non-serving Node Bs, calculating a load factor for each of the one or more non-serving Node Bs, generating a weighted SNPL metric by applying the calculated load factor to a non-weighted SNPL metric determination, and transmitting the generated weighted SNPL metric to a serving Node B.

Another aspect relates to an apparatus for wireless communications. The apparatus can include a receiver configured to receive a load indicator from each of one or more non-serving Node Bs. The apparatus may also include at least one processor configured to calculate a load factor for each of the one or more non-serving Node Bs, and generate a weighted SNPL metric by applying the calculated load factor to a non-weighted SNPL metric determination. The apparatus may further include a transmitter configured to transmit the generated weighted SNPL metric to a serving Node B.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a user equipment (UE) in a telecommunications system.

FIG. 4 is a functional block diagram conceptually illustrating example blocks executed to implement the functional characteristics of one aspect of the present disclosure.

FIG. 5 is a call-flow diagram of a methodology for effectively managing uplink interference in an aspect of the present disclosure.

FIG. 6 is a diagram conceptually illustrating an exemplary wireless communications system in an aspect of the present disclosure.

FIG. 7 is a block diagram of an exemplary wireless communications device configured to effectively managing uplink interference according to an aspect.

FIG. 8 is a block diagram depicting the architecture of a Node B configured to effectively managing uplink interference according to an aspect.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

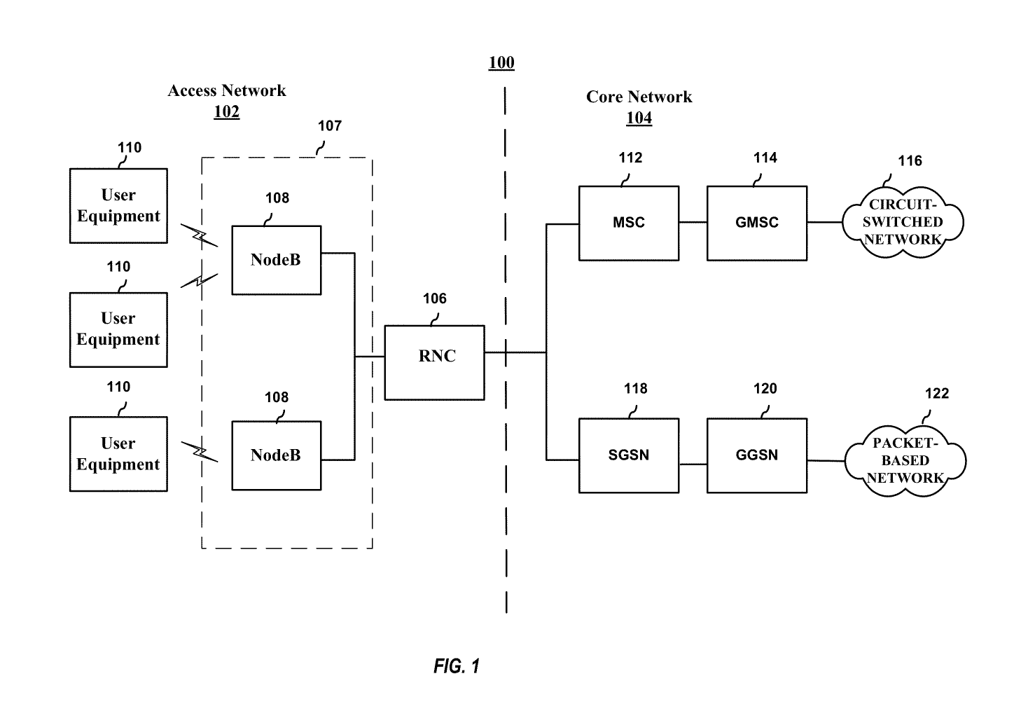

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as UE in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the UL DL between a Node B 108 and a UE 110, but divides uplink and downlink transmissions into different time slots in the carrier.

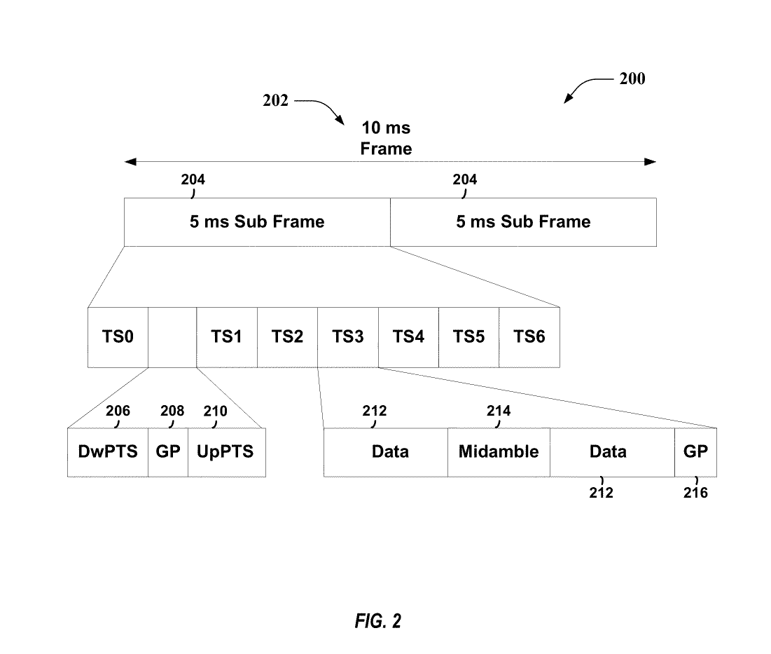

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

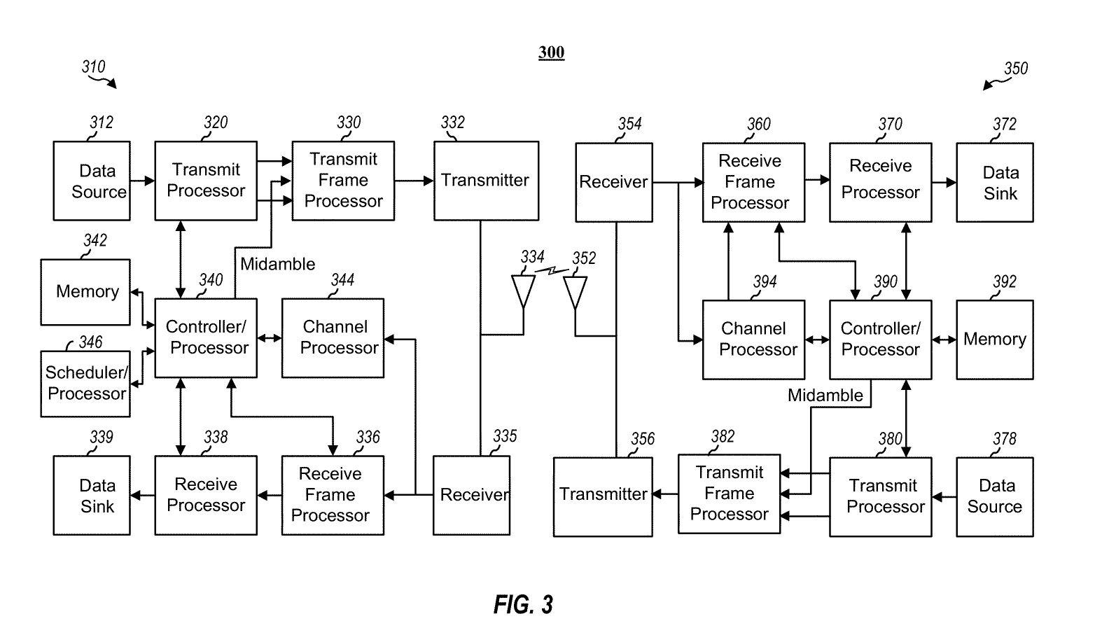

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an ACK and/or NACK protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

In one aspect, controller/processors 340 and 390 may enable resource allocation. Generally, in a TD-SCDMA system efficient resource allocation may be achieved through assignment of resources in such a manner as to maximize system wide efficiency. For example, in TD-SCDMA systems, during optimal usage, a rise-over-thermal (RoT) of all cells may be filled while minimizing the other-cell interference.

In a resource allocation procedure, the UE may receive a load indicator from each of one or more non-serving Node Bs, calculate a load factor for each of the one or more non-serving Node Bs, generate a weighted SNPL metric by applying the calculated load factor to a non-weighted SNPL metric determination, and transmit the generated weighted SNPL metric to a serving Node B.

In one configuration, the apparatus 350 for wireless communication includes means for receiving a load indicator from each of one or more non-serving Node Bs, means for calculating a load factor for each of the one or more non-serving Node Bs, means for generating a weighted SNPL metric by applying the calculated load factor to a non-weighted SNPL metric determination, and means for transmitting the generated weighted SNPL metric to a serving Node B. In one aspect, the means for receiving may include receiver 354. In another aspect, the means for calculating and generating may include controller/processor 390. In still another aspect, the means for transmitting may include transmitter 356. In another configuration, the apparatus 350 includes means for receiving a resource allocation from the serving Node B in response to the transmitted weighted SNPL metric. In another configuration, the apparatus 350 includes means for transmitting the calculated load factor using a request message. In one aspect, the aforementioned means may be the processor(s) 360, 380 and/or 390 configured to perform the functions recited by the aforementioned means. In another aspect, the aforementioned means may be a module or any apparatus configured to perform the functions recited by the aforementioned means.

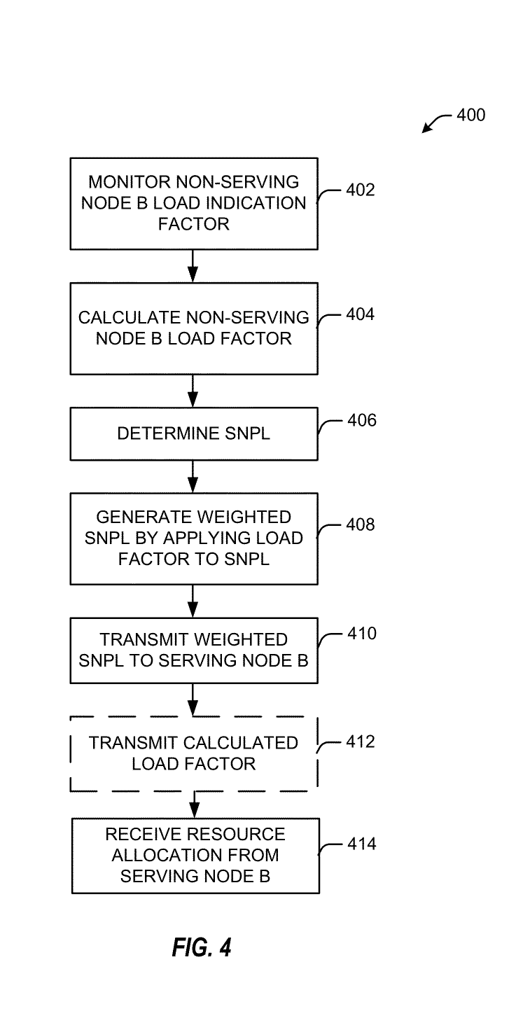

FIG. 4 illustrates various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 4 is a functional block diagram 400 illustrating example blocks executed in conducting wireless communication according to one aspect of the present disclosure. In block 402, a UE may monitor non-serving Node B, (e.g. neighbor Node Bs) to obtain a broadcast load indication bit. In one aspect, the UE may receive a message from a Node B. In one such aspect, the message may be a system information message. In one aspect, the load indicator may be broadcast by each of one or more non-serving Node Bs as a one bit element in each subframe. In another aspect, the one bit element may be included in each subframe by applying a phase shift to a midamble shift assignment. In such an aspect, the load indicator may be indicated as “on” when the applied phase shift is opposite to a phase shift of a common control channel, and the load indicator may be indicated as “off” when the applied phase shift is the same as the phase shift of the common control channel. In one aspect, an uplink load indication may be used at the UE to compute a load percentage. Such a percentage may be used to update a SNPL metric computation.

In block 404, a load factor for each non-serving Node B may be determined In one aspect, the load factor may be computed as a percentage of time slots in which an “on” load indication is received. In another aspect, a load factor may be computed as a weighted average of broadcasts received with an “on” load indication compared with total broadcasts received, over a defined time interval.

In block 406 a SNPL metric is determined In one aspect, the SNPL metric may be determined by calculating a reciprocal of a harmonic sum of a ratio of a serving Node B path loss to each of the one or more non-serving Node B path losses. In another aspect, the SNPL metric may be determined by calculating a ratio of the serving Node B path loss to a minimum of the one or more non-serving Node B path losses.

In block 408, a weighted SNPL may be generated by applying the load factor to the non-weighted SNPL. In other words, the load factor may be applied to the current computed SNPL, which may be based on the path loss to the serving and neighboring cells. As such, the load factor may used as a weighting factor. The weighting factor may be used in a calculation to generate the weighted SNPL as a function of the loading percentage (e.g. load factor) to the SNPL (e.g. path loss) metric. In one aspect, the function may include division of the SNPL by the load factor. For example, assuming a load indicator bit shows 80% binary-zero (e.g. unloaded) and 20% binary-one (e.g., loaded) over a duration of observation for the closest neighboring cell 624, the resulting load factor may be 0.2. In one example, a weighted SNPL value can then be computed as the nominal SNPL value divided by the load factor in the linear domain.

In block 410, the weighted SNPL value, among other values, may be transmitted to the serving Node B. In one aspect, additionally, or optionally, in block 412, the load factor may be transmitted to the Node B. In such an optional aspect, the UE may also report a binary-OR of load indication bits from all cells in its virtual active set as an additional bit in a request message to the Node B. Further, in such an aspect, the UE may also directly provide as feedback a binary-OR of the load indication bit in its virtual active set to the serving Node B to assist in scheduling decisions. The virtual active set may be defined as the set of Node B′s where the path loss to the UE is within a specific threshold. In block 414, the UE may receive resource allocations from the Node B. In one aspect, the resource allocation may be assigned to minimize a UE interference in a region serviced by highly loaded non-serving Node B. In another aspect, the resource allocation may be assigned to maximize a data rate to a UE located near a region serviced by a non-serving Node B which has a low load. Therefore, the Node B scheduler may allow a UE to transmit at higher data rates than it otherwise would.

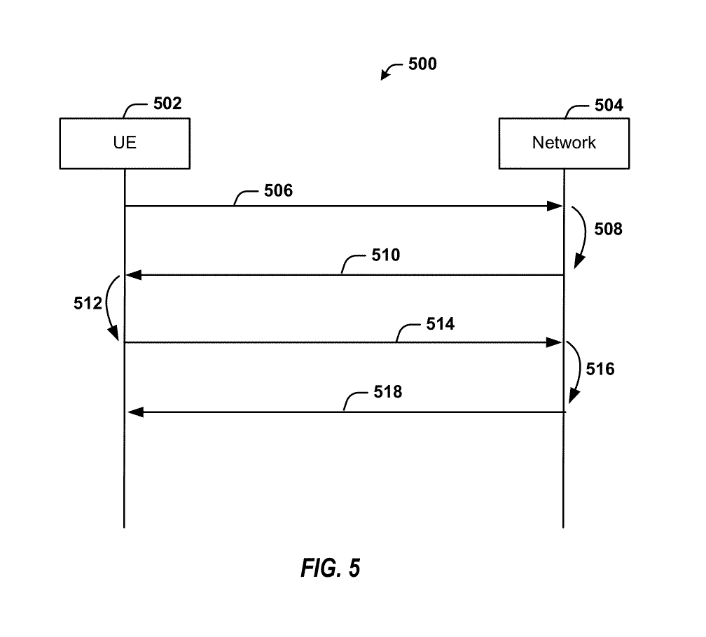

Turning now to FIG. 5, a call flow of an exemplary system 500 for facilitating resource allocation is illustrated. Generally, UE 502 and network 504 may communicate. In one aspect, with high speed uplink capabilities, a given UE 502 can transmit at high data rates upon assignment via scheduling grant from a Node B scheduler 504. As used herein, network 504 may include one or more Node Bs, one or more RNCs, etc.

Returning to FIG. 5, at sequence step 506, UE 502 may transmit a grant request message. In one aspect, the message may include a request to Node B 504 to include information on its power headroom, buffer size, and flow quality of service (QoS) class on an enhanced random access uplink control channel (E-RUCCH) upon initiation. Additionally, UE 502 may monitor various channels, such as an enhanced absolute grant channel (E-AGCH). At sequence step 508, the Node B 504 may receive the request and may make a resource grant decision and communicate this to the UE 502 in terms of an enhanced physical uplink channel (E-PUCH) (e.g., a data channel) and an enhanced hybrid automatic repeat request indication channel (E-HICH) (e.g., a downlink ACK for uplink traffic H-ARQ process) allocation, as well as a maximum payload and modulation format allowed. At sequence step 510, the grant may be transmitted to the UE 502. At sequence step 512, UE 502 may process the received grant and may proceed with data transmission upon the grant and further, at sequence step 514 may proceed with the request/grant process, where the request could be embedded via an enhanced uplink control channel (E-UCCH) multiplexed together with uplink HSUPA traffic transmission. At sequence step 516, uplink control information associated with an enhanced dedicated channel (E-DCH) (e.g., E-UCCH) may be received and an acknowledgement may be calculated in response. At sequence step 518, the acknowledgment may be transmitted to the UE 502.

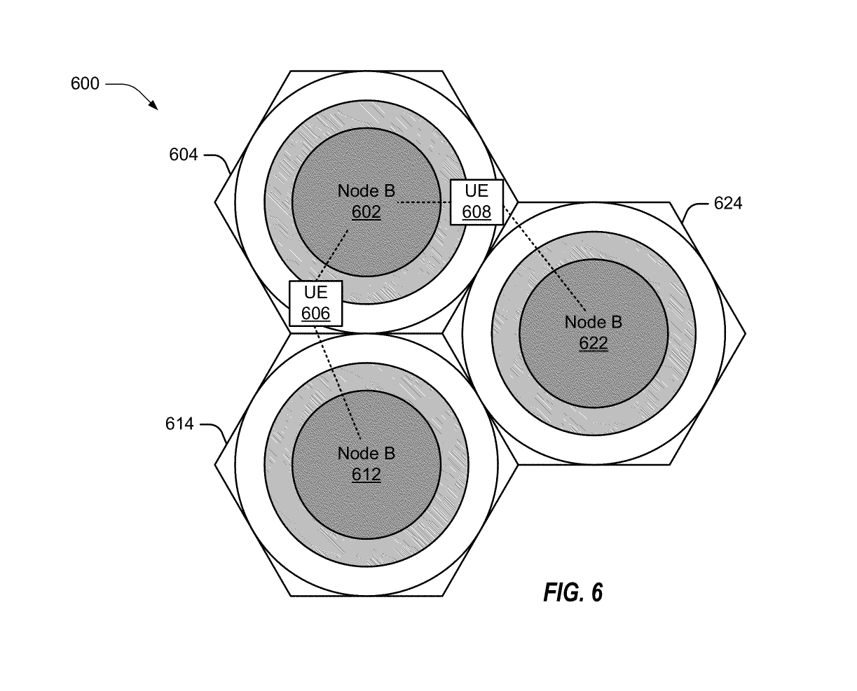

With reference now to FIG. 6, a diagram conceptually illustrating an exemplary wireless communication system 600 is presented. System 600 may include multiple Node Bs (602, 612, 622), where each Node B serves a region (e.g. cell), such as regions 604, 614 and 624 respectively. In one aspect, a serving Node B 602 may service multiple UEs (606, 608). In order to achieve high spectral efficiency, a serving Node B 602 may schedule UE transmissions to ensure that uplink rise-over-thermal (RoT), or equivalently, a target system load, can be filled to a specified threshold and remains steady throughout network operations as long as there is data to transmit for UEs in the cell. Additionally, a Node B scheduling decision may take into account potential interference that a given UE may generate to its neighbors so as to reduce an impact to the RoT of one or more neighboring cells.

In one aspect, serving Node B may allocate resources to UEs (606, 608) in such a manner as to attempt to minimize interference with a neighboring cell which is experiencing high load conditions (e.g. 612), and/or maximize data rates for UEs located where interference with a neighboring cell is not relevant. In one such aspect, a UE may be located near the serving Node B, and as such, neighbor cell interference is not a concern. In another aspect, a UE may be located near a cell 624 served by a Node B 622 which is not experiencing a high load. In such an aspect, the serving Node B may allocate a higher data rate to the UE 608 without concern regarding other cell 624 interference.

In one aspect, in system 600 an average uplink cell throughput may be approximated using equation (1), as follows:

$$KR = \frac{W ( {n}_{UE} - a )}{( 1 + f ) \times \frac{{E}_{b}}{{N}_{t}}} \qquad ( 1 )$$

where α denotes the uplink overhead, η_{UL} denotes the uplink system load target (typically set at 0.75 to 0.8), W denotes the system bandwidth in Hz, Eb/Nt denotes the data channel link efficiency, K denotes the number of UEs in the system, R denotes the per UE average throughput, and f denotes the other-cell interference factor. In order to achieve efficient throughput throughout system 600, it may be beneficial for the rise-over-thermal (RoT) of all cells to be filled, while minimizing the other-cell interference factor f in the network. An effective mechanism in minimizing f may be to reduce the transmit power and thereby reduce instantaneous data rate of cell edge UEs (606, 608).

In one exemplary system 600, such as a time division high speed uplink packet (TD-HSUPA) system, each UE (606, 608) may report a corresponding measurement SNPL to a serving Node B 602 periodically. The transmit power (P_{ref}) (e.g. as measured from a P-CCPCH) of the serving cell 604 and of each intra-frequency neighbor cell (614, 624) may make up a monitored neighbor cell list and can be signaled by higher layers to a UE in order that the UE may estimate a mean path loss to the serving cell (Lₛₑᵣᵥ) and a mean path loss to each of the N neighbor cells in the monitored neighbor cell list (L₁, L₂, . . . L_{N}). Further, the UE may be configured to determine a SNPL metric using various reporting types. The SNPL metric is one way to indicate the amount of interference a potential UE is capable of introducing to neighboring cells. For example, a reporting type 1 may generate the SNPL metric using equation (2), and a reporting type 2 may generate the SNPL metric using equation (3), as follows.

$$\begin{matrix}Φ = \frac{1}{{\sum }_{n = 1}^{N} {L}_{serv} / {L}_{n}} & ( 2 ) \\ Φ = \frac{{min}_{n = 1 … N} ( {L}_{n} )}{{L}_{serv}} & ( 3 )\end{matrix}$$

As the above equations describe, the SNPL can be computed as the reciprocal of the harmonic sum of the ratio of UE serving cell path loss to each of the UE's neighbor cell path loss, where the neighbor cells are ones that are in the UE's neighbor set (equation (2)), as the ratio of the UE serving cell path loss to the minimum of the UE's neighbor cell path losses (equation (3)), etc. In other words, the SNPL is a measure of how close a given UE is to its neighboring cells. As such, a Node B scheduler may process a smaller SNPL metric to assign a lower data rate to the UE to minimize the UE transmit power and hence interference to the other cell.

Generally, SNPL feedback may include all potential cells in its neighbors in the feedback. Further, a SNPL-based indication may not take into account loading of neighboring cells and feedback may be in-band via a long-term process that could not fill the RoT effectively on a short-term scale. As such, the normal SPNL feedback may lead to unnecessary uplink throughput loss in partially loaded systems. For example, in the case of a partially loaded cell (e.g. 602) when a neighboring cell or cells are very lightly loaded (624), such as in the case of a hotspot deployment, by reporting a low SNPL value a UE may overly limit its transmit data rate. In such an aspect, a UE may transmit at higher data rate without risk of interference to the other cell as the other cell load is light. In one aspect, a per cell load indicator bit, (e.g. one-bit information send every subframe to indicate whether the given cell is loaded) may be added to a Node B broadcast. Such a load indicator may allow the Node B to communicate if a current cell load measurement for the current sub-frame is exceeding the load threshold. With this information, the UE could feedback an effective (e.g. weighted) SNPL. Such an effective SNPL may be generated from a nominal SNPL coupled with a per-cell weighted path loss. The weighting may depend on the load of each cell it learns from the loading indication. In one aspect, the weighting function could be a scaling by the percentage of time when a given cell transmits a high load indicator.

In one aspect, each Node B may transmit the load indication during time slot 0 (TS0). Generally, in a TD-SCDMA system, TS0 is used for transmitting downlink overhead information to the UEs including primary common control physical channel (P-CCPCH) and secondary common control physical channel (S-CCPCH), where each overhead occupies a given Walsh dimension for data transmission and a given midamble with K=8 default midamble as pilot. The load indication bit may be transmitted on a predetermined midamble shift (e.g. one or more of 8 possible midamble shift assignments), and the value of the bit may be reflected in a phase of the predetermined midamble, relative to the phase of midamble for P-CCPCH. For example, a binary-zero for the load indicator may result from the phase of the assigned midamble being the same as that of P-CCPCH midamble, and a binary-one for the load indicator may result from the phase of the assigned midamble having an opposite phase as that of P-CCPCH midamble. Furthermore, in one aspect with multiple carriers to be supported in each cell, the time of each carrier loading information delivery via TS0 of a primary carrier can be based on a SFN and carrier number. In such an aspect, it may be up to UE to assure that the neighboring cell loading information of its working carrier is up to date.

In one exemplary operation, assume UE 608 serving cell path loss=X, and the closest non-serving cell 624 path loss is 3 dB higher. Assuming type 2 feedback, the original SNPL value, referred to as nominal SNPL, is then 3 dB. Further, assuming a load indicator bit shows 80% binary-zero (e.g. unloaded) and 20% binary-1 (e.g. loaded) over a duration of observation for the closest neighboring cell 624, the resulting load factor may be 0.2. In one example, an effective SNPL value can then be computed as the nominal SNPL value divided by the load factor (in linear domain). Continuing the above example the UE may feedback an effective SNPL of 3+4.7 dB=7.7 dB. This way the UE may be allowed by the Node B scheduler to transmit at higher data rates than it otherwise would, by a potential margin of 4 dB difference (e.g. more than twice the data rate).

Still further, in one aspect, to extend the application of the one-bit load indication further, a UE may also feedback the load indication it received via a request message, thereby allowing a Node B to make prompt scheduling decisions and achieve higher UL spectral efficiency. A request message may also include information such as, a normal SNPL, UE power headroom, UE data queue buffer size, QoS class of data, etc. Further, the request message may be embedded in a UCCH or RUCCH. The load indication may include load indication bits a UE has observed from all of the cells from a virtual active set. The virtual active set may be a set of Node B's whose path loss, Ec/Io, etc., to the UE is within a specified threshold from that of the UE to the serving cell.

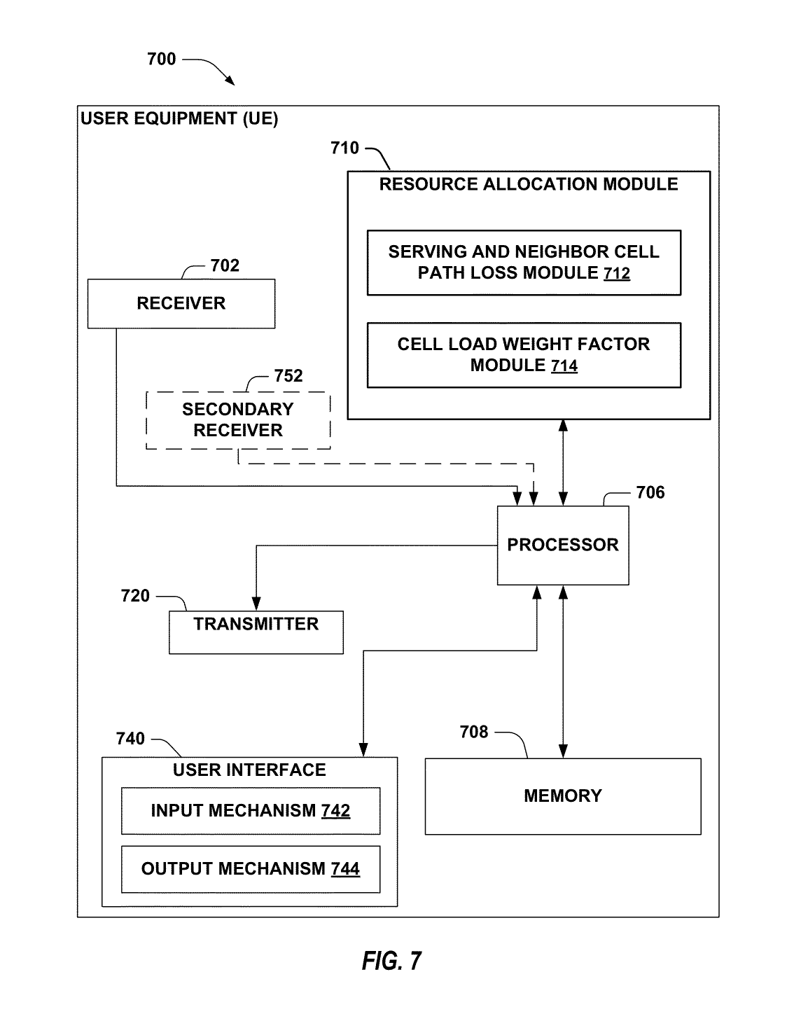

With reference now to FIG. 7, an illustration of a UE 700 (e.g. a client device, wireless communications device (WCD), etc.) that can facilitate obtaining resource allocations is presented. UE 700 comprises receiver 702 that receives one or more signal from, for instance, one or more receive antennas (not shown), performs typical actions on (e.g., filters, amplifies, downconverts, etc.) the received signal, and digitizes the conditioned signal to obtain samples. Receiver 702 can further comprise an oscillator that can provide a carrier frequency for demodulation of the received signal and a demodulator that can demodulate received symbols and provide them to processor 706 for channel estimation. In one aspect, UE 700 may further comprise secondary receiver 752 and may receive additional channels of information.

Processor 706 can be a processor dedicated to analyzing information received by receiver 702 and/or generating information for transmission by one or more transmitters 720 (for ease of illustration, only one transmitter is shown), a processor that controls one or more components of UE 700, and/or a processor that both analyzes information received by receiver 702 and/or receiver 752, generates information for transmission by transmitter 720 for transmission on one or more transmitting antennas (not shown), and controls one or more components of UE 700.

UE 700 can additionally comprise memory 708 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.).

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 708 of the subject systems and methods is intended to comprise, without being limited to, these and any other suitable types of memory.

UE 700 can further comprise resource allocation module 710 which may be operable to obtain assigned resources for UE 700. In one aspect, resource allocation module 710 may include SNPL module 712 and cell load weight factor module 714. In one aspect, SNPL module 712 is operable calculate a SNPL metric. In one aspect, the SNPL metric may be determined either by calculating a reciprocal of a harmonic sum of a ratio of a serving Node B path loss to each of the one or more non-serving Node B path losses, or by calculating a ratio of the serving Node B path loss to a minimum of the one or more non-serving Node B path losses. In one aspect, cell load weight factor module 714 may be operable determine a cell load factor by analyzing received load indication values. Operation of such resource allocation is depicted in FIGS. 4 and 5.

Moreover, in one aspect, processor 706 may provide the means for receiving a load indicator from each of one or more non-serving Node Bs, means for calculating a load factor for each of the one or more non-serving Node Bs, means for generating a weighted SNPL metric by applying the calculated load factor to a non-weighted SNPL metric determination, and means for transmitting the generated weighted SNPL metric to a serving Node B.

Additionally, UE 700 may include user interface 740. User interface 740 may include input mechanisms 742 for generating inputs into UE 700, and output mechanism 742 for generating information for consumption by the user of UE 700. For example, input mechanism 742 may include a mechanism such as a key or keyboard, a mouse, a touch-screen display, a microphone, etc. Further, for example, output mechanism 744 may include a display, an audio speaker, a haptic feedback mechanism, a Personal Area Network (PAN) transceiver etc. In the illustrated aspects, output mechanism 744 may include a display operable to present content that is in image or video format or an audio speaker to present content that is in an audio format.

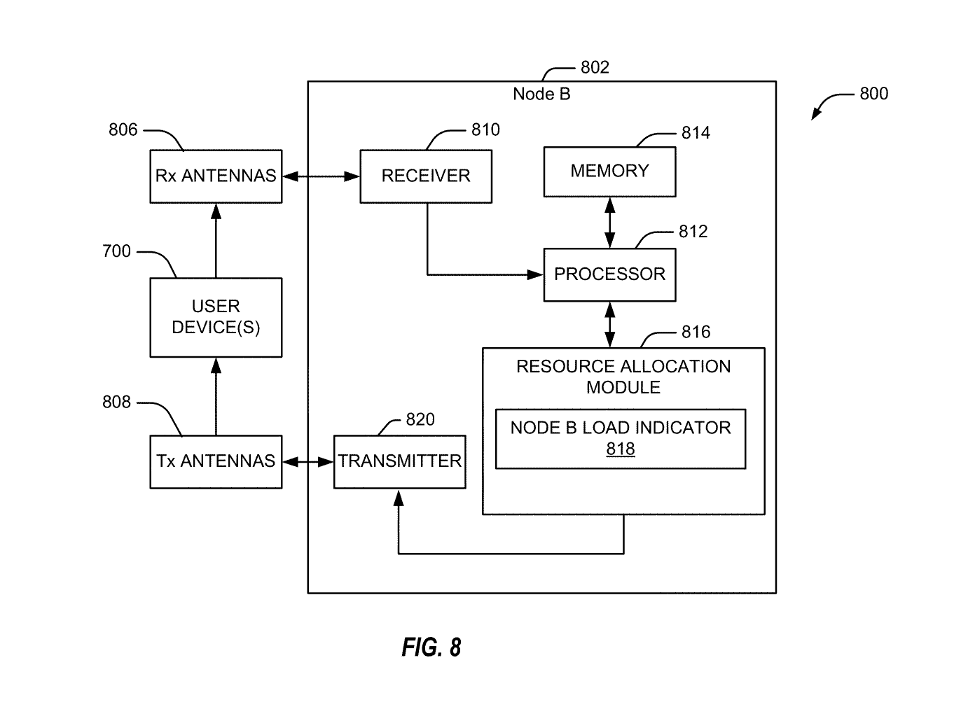

With reference to FIG. 8, an example system 800 that comprises a Node B 802 with a receiver 810 that receives signal(s) from one or more user devices 700 through a plurality of receive antennas 806, and a transmitter 820 that transmits to the one or more user devices 800 through a plurality of transmit antennas 808. Receiver 810 can receive information from receive antennas 806. Symbols may be analyzed by a processor 812 that is similar to the processor described above, and which is coupled to a memory 814 that stores information related to data processing. Processor 812 is further coupled to a resource allocation module 816 that facilitates communications with one or more respective user devices 700 for assigning resources.

In one aspect, resource allocation module 816 may be operable to provide efficient throughout for network 800. Further, resource allocation module 816 may include load indicator 818. In one aspect, load indicator 818 may include a bit transmitted by each cell in TS0 via a midamble where the bit value is reflected as its relative phase to that of P-CCPCH midamble. In one aspect, the load indicator 818 may be broadcast by each of the one or more non-serving Node Bs as a one bit element in each subframe may receive a message from a Node B. In another aspect, the one bit element may be included in each subframe by applying a phase shift to a midamble shift assignment the message may be a system information message. In such an aspect, the load indicator 818 may be indicated as “on” when the applied phase shift is opposite to a phase shift of a common control channel, and the load indicator may be indicated as “off” when the applied phase shift is the same as the phase shift of the common control channel.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, HSDPA, High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a time division synchronous code division multiple access (TD-SCDMA) system, comprising:
receiving a load indicator from each of one or more non-serving Node Bs;
calculating a load factor for each of the one or more non-serving Node Bs;
generating a weighted serving and neighbor Node B path loss (SNPL) metric by applying the calculated load factor to a non-weighted SNPL metric determination; and
transmitting the generated weighted SNPL metric to a serving Node B.

2. The method of claim 1, further comprising:
receiving a resource allocation from the serving Node B in response to the transmitted weighted SNPL metric.

3. The method of claim 2, wherein the resource allocation is assigned to minimize a UE interference to a region serviced by highly loaded non-serving Node B.

4. The method of claim 2, wherein the resource allocation is assigned to maximize a data rate to a UE located near a region serviced by a non-serving Node B which has a low load.

5. The method of claim 1, further comprising:
transmitting the calculated load factor using a request message.

6. The method of claim 1, wherein the load indicator is broadcast by each of the one or more non-serving Node Bs as a one bit element in each subframe.

7. The method of claim 6, wherein the one bit element is included in each subframe by applying a phase shift to a midamble shift assignment.

8. The method of claim 7, wherein the load indicator is indicated as on when the applied phase shift is opposite to a phase shift of a common control channel, and the load indicator is indicated as off when the applied phase shift is the same as the phase shift of the common control channel.

9. The method of claim 1, wherein the non-weighted SNPL metric is determined either by calculating a reciprocal of a harmonic sum of a ratio of a serving Node B path loss to each of the one or more non-serving Node B path losses, or by calculating a ratio of the serving Node B path loss to a minimum of the one or more non-serving Node B path losses.

10. The method of claim 1, wherein the wireless communication is performed in a time division high speed uplink packet access (TD-HSUPA) system.

11. An apparatus for wireless communication in a TD-SCDMA system, comprising:
means for receiving a load indicator from each of one or more non-serving Node Bs;
means for calculating a load factor for each of the one or more non-serving Node Bs;
means for generating a weighted SNPL metric by applying the calculated load factor to a non-weighted SNPL metric determination; and
means for transmitting the generated weighted SNPL metric to a serving Node B.

12. The apparatus of claim 11, wherein the means for receiving further comprises:
means for receiving a resource allocation from the serving Node B in response to the transmitted weighted SNPL metric.

13. The apparatus of claim 12, wherein the resource allocation is assigned to minimize a UE interference to a region serviced by highly loaded non-serving Node B.

14. The apparatus of claim 12, wherein the resource allocation is assigned to maximize a data rate to a UE located near a region serviced by a non-serving Node B which has a low load.

15. The apparatus of claim 12, wherein the means for transmitting further comprises:
means for transmitting the calculated load factor using a request message.

16. The apparatus of claim 11, wherein the load indicator is broadcast by each of the one or more non-serving Node Bs as a one bit element in each subframe.

17. The apparatus of claim 16, wherein the one bit element is included in each subframe by applying a phase shift to a midamble shift assignment.

18. The apparatus of claim 17, wherein the load indicator is indicated as on when the applied phase shift is opposite to a phase shift of a common control channel, and the load indicator is indicated as off when the applied phase shift is the same as the phase shift of the common control channel.

19. The apparatus of claim 11, wherein the non-weighted SNPL metric is determined either by calculating a reciprocal of a harmonic sum of a ratio of a serving Node B path loss to each of the one or more non-serving Node B path losses, or by calculating a ratio of the serving Node B path loss to a minimum of the one or more non-serving Node B path losses.

20. The apparatus of claim 11, wherein the wireless communication is performed in a TD-HSUPA system

21. A computer program product, comprising:
a computer-readable medium comprising code for:
receiving a load indicator from each of one or more non-serving Node Bs;
calculating a load factor for each of the one or more non-serving Node Bs;
generating a weighted SNPL metric by applying the calculated load factor to a non-weighted SNPL metric determination; and
transmitting the generated weighted SNPL metric to a serving Node B.

22. The computer program product of claim 21, wherein the computer-readable medium further comprises code for:
receiving a resource allocation from the serving Node B in response to the transmitted weighted SNPL metric.

23. The computer program product of claim 22, wherein the resource allocation is assigned to minimize a UE interference to a region serviced by highly loaded non-serving Node B.

24. The computer program product of claim 22, wherein the resource allocation is assigned to maximize a data rate to a UE located near a region serviced by a non-serving Node B which has a low load.

25. The computer program product of claim 21, wherein the computer-readable medium further comprises code for:
transmitting the calculated load factor using a request message.

26. The computer program product of claim 21, wherein the load indicator is broadcast by each of the one or more non-serving Node Bs as a one bit element in each subframe.

27. The computer program product of claim 26, wherein the one bit element is included in each subframe by applying a phase shift to a midamble shift assignment.

28. The computer program product of claim 27, wherein the load indicator is indicated as on when the applied phase shift is opposite to a phase shift of a common control channel, and the load indicator is indicated as off when the applied phase shift is the same as the phase shift of the common control channel.

29. The computer program product of claim 21, wherein the non-weighted SNPL metric is determined either by calculating a reciprocal of a harmonic sum of a ratio of a serving Node B path loss to each of the one or more non-serving Node B path losses, or by calculating a ratio of the serving Node B path loss to a minimum of the one or more non-serving Node B path losses.

30. The computer program product of claim 21, wherein the wireless communication is performed in a TD-HSUPA system

31. An apparatus for wireless communication in a TD-SCDMA system, comprising:
at least one processor; and
a memory coupled to the at least one processor,
a receiver configured to receive a load indicator from each of one or more non-serving Node Bs;
wherein the at least one processor is configured to:
calculate a load factor for each of the one or more non-serving Node Bs; and
generate a weighted SNPL metric by applying the calculated load factor to a non-weighted SNPL metric determination; and
a transmitter configured to transmit the generated weighted SNPL metric to a serving Node B.

32. The apparatus of claim 31, wherein the receiver is further configured to:
receive a resource allocation from the serving Node B in response to the transmitted weighted SNPL metric.

33. The apparatus of claim 32, wherein the resource allocation is assigned to minimize a UE interference to a region serviced by highly loaded non-serving Node B.

34. The apparatus of claim 32, wherein the resource allocation is assigned to maximize a data rate to a UE located near a region serviced by a non-serving Node B which has a low load.

35. The apparatus of claim 31, wherein the transmitter is further configured to:
transmit the calculated load factor using a request message.

36. The apparatus of claim 31, wherein the load indicator is broadcast by each of the one or more non-serving Node Bs as a one bit element in each subframe.

37. The apparatus of claim 36, wherein the one bit element is included in each subframe by applying a phase shift to a midamble shift assignment.

38. The apparatus of claim 37, wherein the load indicator is indicated as on when the applied phase shift is opposite to a phase shift of a common control channel, and the load indicator is indicated as off when the applied phase shift is the same as the phase shift of the common control channel.

39. The apparatus of claim 31, wherein the non-weighted SNPL metric is determined either by calculating a reciprocal of a harmonic sum of a ratio of a serving Node B path loss to each of the one or more non-serving Node B path losses, or by calculating a ratio of the serving Node B path loss to a minimum of the one or more non-serving Node B path losses.

40. The apparatus of claim 31, wherein the wireless communication is performed in a TD-HSUPA system.
